(19) United States
(12) Patent Application Publication
(10) Pub. No.: US 2023/0235626 A1
(43) Pub. Date: Jul. 27, 2023

(54) WINDOW TREATMENT CHAIN OR CORD PROTECTOR

(71) Applicant: 1067375 ONTARIO INC., Ottawa (CA)

(72) Inventor: Ted Barkun, Nepean (CA)

(21) Appl. No.: 18/096,879

(22) Filed: Jan. 13, 2023

Related U.S. Application Data
(60) Provisional application No. 63/299,072, filed on Jan. 13, 2022.

(51) Int. Cl. E06B 9/326

(52) U.S. Cl. CPC E06B 9/326

(57) ABSTRACT

A protector for a cord or chain of a window treatment is disclosed. The protector includes a control tube having an interior cavity for receiving the cord or chain, a first open end, a second open end, and a closable opening for accessing the cord or chain. In operation, the chain or cord is fed around a pulley positioned within the interior cavity of the control tube. The pulley is rotatable about a shaft insertable through at least one pair of openings in the control tube proximate the first or second open end. A corresponding method of protecting a cord or chain of a window treatment is also disclosed.

### CROSS REFERENCE TO RELATED APPLICATION

This application claims the benefit of U.S. Provisional Pat. Application No. 63/299,072 filed Jan. 13, 2022, which is hereby incorporated by reference.

### FIELD

This application relates generally to a protector or guard for chains or cords for window treatments, such as drapes and blinds.

### BACKGROUND

Endless cords and endless chains are used to control window treatments such as blinds and drapes, allowing users to open, close, raise, lower or adjust elements of the window treatments. Cords and chains may hang from one end of the treatment and, if needed, are maintained under tension, to allow for access and operation. However, this may also present a hazard, particularly for young children, who might get body parts caught and tangled. In extreme cases, this may even result in strangulation. Therefore, regulations and industry standards have evolved to reduce and mitigate this risk. Nonetheless, there is a continued desire for simple yet effective protection against the risk presented by such chains and cords of windows treatments.

### SUMMARY

According to some embodiments of the present disclosure, there is provided a protector for a cord or chain of a window treatment, the protector comprising a control tube having: an interior cavity for receiving the cord or chain, a first open end, a second open end, and a closable opening for accessing the cord or chain, wherein, in operation, the chain or cord is fed around a pulley positioned within the interior cavity of the control tube, and wherein the pulley is rotatable about a shaft insertable through at least one pair of openings in the control tube proximate the first or second open end.

According to some embodiments, there is provided a method of installing a protector for a chain or cord of a window treatment, the method comprising: providing: a control tube having an interior cavity for receiving the cord or chain, a first open end, a second open end, and a closable opening for accessing the cord or chain, a pulley, and one or more pins; feeding the chain or cord through the first and second open ends of the control tube and around the pulley; aligning a center hole of the pulley with a first pair of holes in the control tube; and inserting a pin of the one or more pins through the first pair of holes and the center hole.

### BRIEF DESCRIPTION OF THE DRAWINGS

The foregoing summary, as well as the following detailed description of illustrative embodiments of the present application, will be better understood when read in conjunction with the appended drawings. For the purposes of illustrating the present application, there is shown in the drawings illustrative embodiments of the disclosure. It should be understood, however, that the application is not limited to the precise arrangements and instrumentalities shown. In the drawings:

FIG. 1 shows an embodiment of an assembled protector according to the present disclosure.

FIG. 2 shows an exploded view of the protector of FIG. 1.

FIG. 3 shows a pulley enclosure of the protector of FIG. 1.

FIG. 4 shows a control tube of the protector of FIG. 1.

FIG. 5 shows an extension tube of the protector of FIG. 1.

FIG. 6 shows an exploded view of another embodiment of a protector according to the present disclosure.

FIG. 7 shows a first configuration of the pulley enclosure and control tube of the protector of FIG. 6.

FIG. 8 shows a second configuration of the pulley enclosure and control tube of the protector of FIG. 6.

FIG. 9 shows an exploded view of another embodiment of a protector according to the present disclosure.

### DETAILED DESCRIPTION

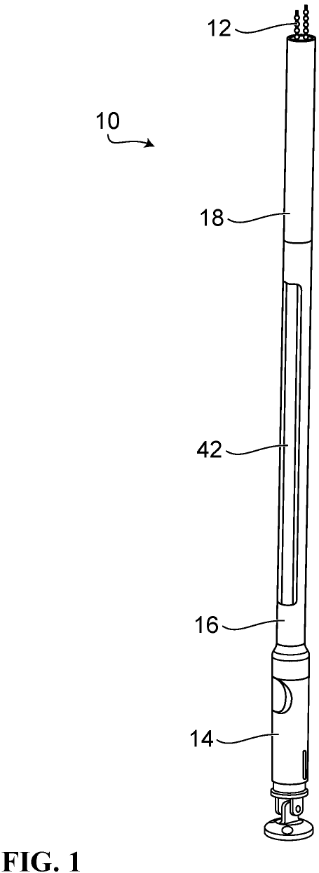

Referring to FIG. 1, one embodiment of a cord or chain protector 10 is shown. The principles of the present invention may be applied to both chains and cords and therefore any reference to one should be understood as also including reference to the other. As such, the embodiment of the chain protector of FIG. 1 can also be used for cords, as needed.

The chain protector 10 is used to effectively protect and enclose an endless chain 12 of a window treatment (not shown), while also allowing the chain 12 to remain under required tension and permitting access to the chain or cord for operation. As will be described below, the protector 10 includes multiple components that permit customization so that a desired length of chain 12 can be fully or partially enclosed and the operational access can be positioned at a desired height to avoid access by children. The protector 10 also includes features to prevent unwanted access by children, even in the event that an adult user fails to properly re-secure the protector.

The protector 10 includes a mountable, tension pulley enclosure 14, a control tube 16, and one or more extension tubes 18 (only one extension tube shown).

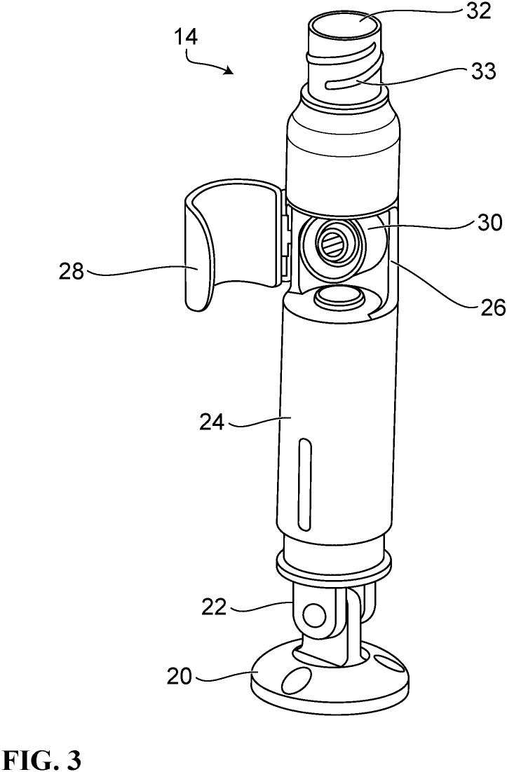

The tension pulley enclosure 14 includes an optional base 20, mountable to the floor or a wall, a hinge 22, allowing for pivotal movement of a body 24 with respect to the base 20, and an opening 26 with hinged door 28. Within the body 24, a pulley 30 is arranged. The cavity, within which the pulley is positioned, is accessible via the door 28 and communicates through the body 24 with an opening 32 at a top of the body 24. A tapered, threaded connection portion 33 is positioned at the top of the enclosure 14. Chain 12 is fed through the opening 32 and around the pulley 30. The pulley 24 is spring loaded to provide a desired tension to the chain 12. The door 28 may be spring loaded to ensure it closes if left open and may also include one or more latches, such as magnetic latches, to help ensure it latches and/or remains closed, as shown for example in FIG. 3.

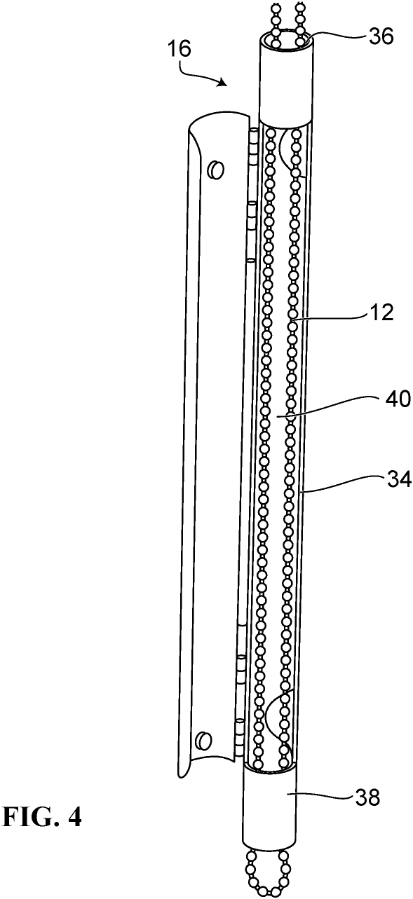

The control tube 16 is generally formed as a hollow tube body 34 having top and bottom connection portions 36, 38, each with either a female or male threaded connection. An opening 40 is provided on a side of the tube body 34, with a hinged door 42 for providing access to the internal cavity of the tube body 34. The door 42 provides access to the chain 12 extending through the interior of the tube body 34, as shown in FIG. 4. The opening 40 is sized to permit a user to access and control the chain 12, i.e. to allow a user to pull on either side of the chain 12. The door 42 may be spring loaded to ensure it closes if left open and may include one or more latches, such as magnetic latches, to help ensure it latches and/or remains closed.

Both the door 28 of the pulley enclosure 14 and the door 42 of the control tube 16 may be formed to match the surface contour of the enclosure and tube, respectively. For example, the door may be curved with a radius of curvature that matches the radius of curvature of the enclosure. This may aid in maintaining a uniform appearance and also increase the difficulty for a child to identify and open the door, exposing the chain which is securely fitted around the wheel 30. A small recess, tab, knob or other element may be provided to aid in opening the door if closed.

The extension tube 18 is generally formed as a hollow tube body 44 having top and bottom connection portions 46, 48, each with either a female or male threaded connection. The extension tube 18 may be of a desired length and a protector according to the present disclosure may be comprised of one or more extension tubes 18, of the same or differing lengths, to accommodate different lengths of chain and different heights at which the control tube is to be positioned.

To assemble the protector 10, the enclosure 14, control tube 16, and one or more extension tubes 18 are arranged in a desired configuration. The control and extension tubes 16, 18 are then screwed into each other and then to enclosure 14 to ensure a snug fit and a continuous protector housing. The chain or cord 12 is fed through the successive extension tubes 18 and control tube 16 and into the enclosure 14, where it is tensioned around the pulley 30. The number and/or lengths of the extension tubes 18 required may be determined by the height required to be used in order to avoid accessibility by a child.

In operation, the door 42 of the control tube may be opened to control the chain 12. The door 42 is again closed to prevent unwanted and hazardous access to the chain 12 by, for example, children. This may be wholly or in part because the door 42 is too high off the floor to be reached and/or because the door 42 requires more force to open than can be applied by a child. Moreover, even if opened, the reduced excess slack of the chain 12 within the control tube because of the tensioning of the pulley 30 - as well as the dimensions of the interior of the protector - may make it more difficult for the chain 12 to be looped around, for example, a child’s neck or head.

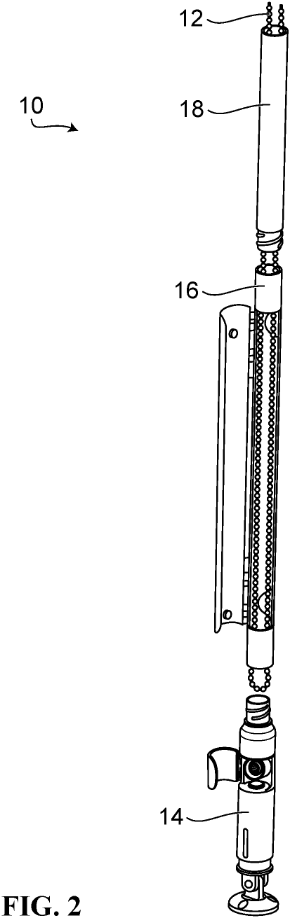

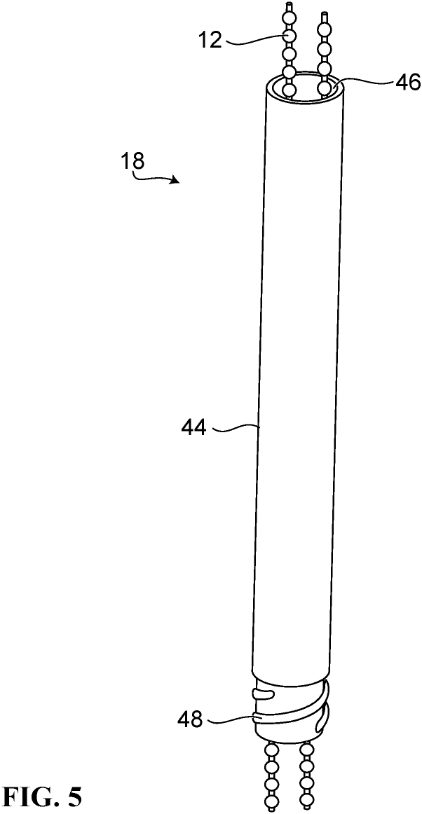

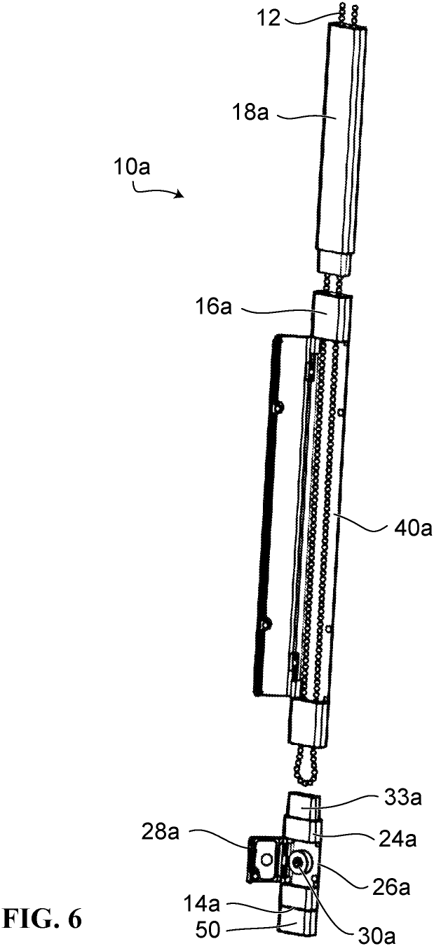

FIG. 6 shows a further embodiment of a chain protector, particularly suited for blinds. As compared with the embodiment shown in FIGS. 1-5, like elements will be referred to with like numerals but with the addition of “a” to denote the different embodiment. Unless indicated otherwise, the description of the embodiment shown in FIGS. 1 to 5 applies mutatis mutandis to the embodiment of FIG. 6.

The embodiment of the protector 10a shown in FIG. 6 includes a reversible pulley enclosure 14a, a control tube 16a and one or more extension tubes 18a (only one shown). The protector 10a has an oblong rectangular cross section, as opposed to a circular cross section as shown in the embodiment of FIGS. 1 to 5. The oblong rectangular cross-section may permit for wider openings, such as openings 26a and 40a in the pulley enclosure 14a and control tube 16a, respectively. This cross-sectional shape also prevents rotation of the individual components with respect to each other, while also permitting a press-fitting of the components so that the enclosure 14a can be reversed, as discussed below.

The enclosure 14a may include a tensioned pulley to permit proper operation of the blind chain 12. In the illustrated embodiment, the enclosure 14a omits a base as compared to the embodiment of FIGS. 1 to 5. Instead, the bottom end of the body 24a is capped off and may hang from the window treatment. Furthermore, the connection portion 33a at the top of the body 24a is not threaded and instead forms a tapered male connection portion for forming an interference fit with a respective female connector opening in the control or extension tubes 16a, 18a. Similarly, the bottom end of the extension tube 18a does not have a threaded connection but a female connector for receiving the male connection portion in an interference fit, complementary to that of the enclosure 14a.

Furthermore, the tube 16a may be reversible to allow for easy accessibility depending on whether the chain or cord is mounted on the right or left side of the window treatment. A cap 50 is placed onto the unused connector 33a to cover and form the bottom of the enclosure 14a, depending on its configuration. Namely, depending on which side of the window treatment the chain is located on, the enclosure 14a may be inserted into the control tube16a or extension tube 18a with the hinged doors 28a and 42a opening to the left or right when viewed from the front. To have the doors opening in the same direction, the control tube 16a may be inverted and turned 180 degrees and inserted “upside down” onto the enclosure 14a.

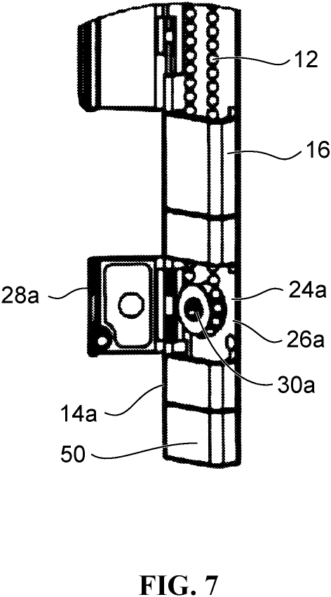

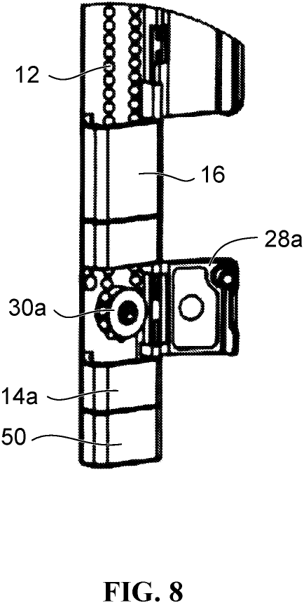

Opening to the left, as shown in FIG. 7, may be desirable when the chain is positioned on the right side of the window treatment when viewed from the front. Opening to the right, as shown in FIG. 8, may be desirable when the chain is positioned on the left of the window treatment when viewed from the front. It is noted that the reversible aspect of the pulley enclosure is not required in all embodiments. In some embodiments, the desired positioning and accessibility of this part is determined only once, at the time of the installation, and would not be required to change once the cord or chain has been mounted around the wheel or pulley 30a.

As with the embodiment of FIGS. 1 to 5, one or more extension tubes 18a of the same or differing height may be inserted between the enclosure 14a and control tube 16a to obtain a desired height for access to the chain 12. One or more extension tubes 18a may also be installed above the control tube 16a to cover further portions of the exposed chain.

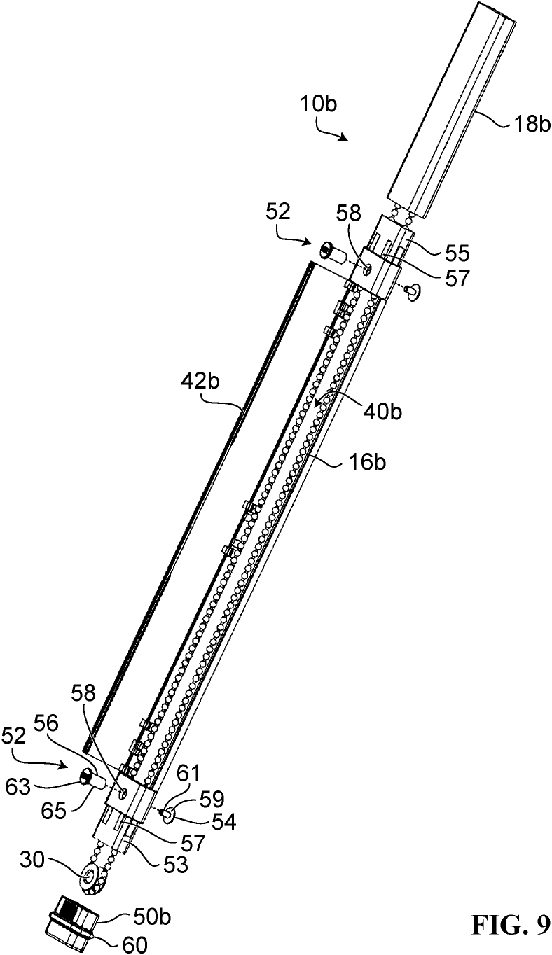

FIG. 9 shows a further embodiment of a chain protector, particularly suited for blinds. As compared with the embodiment shown in FIGS. 6-8, like elements will be referred to with like numerals but with the addition of “b” to denote the different embodiment. Unless indicated otherwise, the description of the embodiment shown in FIGS. 6 to 8 applies mutatis mutandis to the embodiment of FIG. 9.

The embodiment of the protector 10b shown in FIG. 9 includes a control tube 16b and one or more extension tubes 18b (only one shown). The protector 10b has an oblong rectangular cross section, similar to the cross-section of the embodiment shown in FIGS. 6 to 8. The oblong rectangular cross-section may permit for wider openings, such as opening 40b. This cross-sectional shape also prevents rotation of the individual components with respect to each other, while also permitting a press-fitting of the components. The control tube 16b can be reversed, as discussed below.

As compared to the embodiment of FIGS. 6 to 8, the embodiment of FIG. 9 does not include a separate pulley enclosure and instead includes a free pulley 30b that rotates about the shaft of a pin 52, as described further below. Moreover, the control tube 16b includes first and second open ends 53 and 55, respectively, that are configured as connection portions to be inserted into, for example, the extension tube 18b or cap 50b. In particular, the first and second open ends 53 and 55 may be configured to have a cross-section complementary to and insertable into an extension tube 18b and/or cap 50b. Wedges 57 may be provided on the outer surface of the connection portions to aid in maintaining an interference fit.

In the embodiment shown, the pin 52 comprises an insert pin 54 having a head 59 and a shaft 61 and a socket pin 56 have a head 63 and a hollow shaft 65. The shaft 61 of the insert pin 54 is sized to be inserted and held in place with an interference fit in the hollow shaft 65 of the socket pin 56 to form the pin 52. Each of the insert pin 54 and socket pin 56 are inserted into opposing holes 58 formed in the control tube 16b, the holes 58 being sized to accept the hollow shaft 65 of the socket pin 56 and support its rotation with a desirable amount of clearance. The length of the hollow shaft 65 of the socket pin 56 is sized to bridge the thickness of the control tube 16 between opposing holes 58. The respective heads 59 and 63 of the insert pin 54 and socket pin 56 are sized to prevent the pin 52 from falling out of either side of the control tube 16b.

As shown in FIG. 9, the control tube 16b includes two pairs of holes 58, one pair proximate either open end 53 and 55 of the control tube 16b. This allows the control tube 16b to be inverted, reversing the direction of opening of the door 42b depending on what side of the window treatment a user wishes to install the protector 10b.

Namely, to install the protector 10b, a user determines which direction the door 28b is to be opened. The protector 10b is then oriented accordingly and the chain or cord is fed through the one or more extension tubes 18b, if used, into and through the control tube 16b. The chain or cord is then fed around the pulley 30b. The pulley 30b is positioned within the control tube 16b and a center hole 67 of the pulley 30b is aligned with the holes 58 at the lower end of the control tube 16b in its desired orientation. The insert pin 54 and socket pin 56 are then installed to maintain the pulley 30b in place and permit it to rotate.

The shaft 61 of the insert pin 54 and/or hollow shaft 65 of the socket pin 56 may have locking features to help prevent the shaft 61 from disengaging from the hollow shaft 65 and to thereby keep the pulley 30b in place following initial installation.

Other embodiments of the pin and pulley system maybe used. For example, the pin may be installed in a different manner and/or the chain or cord may be fed around a differently configured pulley.

The cap 50b may then be installed by press fit onto the lower open end of the control tube 16b. A friction bumper ring 60, such as a rubber ring, may be included on the cap 50b to provide for bumper contact with a wall surrounding the window treatment.

A second pin 52 may be installed in the upper pair of holes 58. In that position, the second pin 52 may act as a guide for the cord or chain and may aid in preventing the chain or cord from tangling.

It will be appreciated that while the present description makes reference to a control chain to be protected, the principles of the present disclosure apply to other types of elongated controls, such as cords, strings, etc.

Moreover, should one not wish to have the cord or chain protector secured due to an individual’s restrictive capabilities, such as a wheel chair, the door to the cord or chain sections of the protector remains restricted to children due to, for example, the inclusion of a spring hinge and/or latch on the control access doors, making it difficult for a child to have access to the chain or cord.

While the invention has been described so far in terms of an apparatus, the present disclosure also encompasses novel and inventive methods. According to some embodiments of the present disclosure, there is provided a method for protecting or securing a chain or cord of a window treatment, including the steps of providing a pulley enclosure and a control tube, feeding the chain through the control tube and into the pulley, securing the chain on the pulley, and operating the chain through an opening in the control tube. Other methods are also possible.

In some embodiments, there is provided a method of installing a protector for a chain or cord of a window treatment. The method includes providing a control tube, such as the control tube 10b, the control tube having an interior cavity for receiving the cord or chain, a first open end, a second open end, and a closable opening for accessing the cord or chain,a pulley, and at least one pin. The method further includes feeding the chain or cord through the first and second open ends of the control tube and around the pulley. Moreover, the method includes aligning a center hole of the pulley with a first pair of holes in the control tube and, finally, inserting a pin through the first pair of holes and the center hole.

Numerous specific details have been set forth in order to provide a more thorough understanding of the inventive concepts. However, it will be apparent to one of ordinary skill in the art that the inventive concepts within the instant disclosure may be practiced without these specific details. In other instances, well-known features have not been described in detail to avoid unnecessarily complicating the instant disclosure.

As used herein, terms such as “top”, “bottom”, “front”, “rear”, “downwards”, “upwards” and other directional terms are intended to aid in discussion of the relative features of embodiments of the disclosure, but are not limiting. It will be understood that these terms may be reversed or switched without altering the scope of the disclosure.

As used herein, the terms “comprises,” “comprising,” “includes,” “including,” “has,” “having” or any other variation thereof, are intended to cover a nonexclusive inclusion. For example, a composition, a process, method, article, or apparatus that comprises a list of elements is not necessarily limited to only those elements but may include other elements not expressly listed or inherently present therein.

As used herein the terms “approximately,” “about,” “substantially” and variations thereof are intended to include not only the exact value qualified by the term, but to also include some slight deviations therefrom, such as deviations caused by measuring error, manufacturing tolerances, wear and tear on components or structures, stress exerted on structures, and combinations thereof, for example.

Use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Moreover, it will be understood that features of one embodiment may be combined with features of other embodiments, even if not expressly recited or described as a combination.

1. A protector for a cord or chain of a window treatment, the protector comprising a control tube having:
an interior cavity for receiving the cord or chain,
a first open end,
a second open end, and
a closable opening for accessing the cord or chain,
wherein, in operation, the chain or cord is fed around a pulley positioned within the interior cavity of the control tube, and wherein the pulley is rotatable about a shaft insertable through at least one pair of openings in the control tube proximate the first or second open end.

2. The protector of claim 1, further comprising one or more extension tubes connectable to the first and second open end.

3. The protector of claim 1, wherein the first and second open ends are configured as connection portions.

4. The protector of claim 1, wherein a respective pair of openings for receiving the shaft is provided proximate each of the first and second open ends.

5. The protector of claim 4, wherein a respective pin is inserted in each pair of openings.

6. The protector of claim 1, wherein the shaft forms part of a pin insertable into the at least one pair of openings.

7. The protector of claim 6, wherein the pin is comprised of an insert pin inserted into a socket pin.

8. The protector of claim 1, further comprising a cap for connecting to one of the first and second open ends.

9. The protector of claim 1, wherein the control tube comprises a spring-loaded door to close the closable opening.

10. A method of installing a protector for a chain or cord of a window treatment, the method comprising:
providing:
a control tube having an interior cavity for receiving the cord or chain, a first open end, a second open end, and a closable opening for accessing the cord or chain,
a pulley, and
one or more pins;
feeding the chain or cord through the first and second open ends of the control tube and around the pulley;
aligning a center hole of the pulley with a first pair of holes in the control tube; and
inserting a pin of the one or more pins through the first pair of holes and the center hole.

11. The method of claim 10, further comprising inserting a pin of the one or more pins through a second pair of holes in the control tube.

12. The method of claim 10, wherein inserting the pin comprises inserting a hollow shaft of a socket pin through the first pair of holes and inserting an insert pin into the hollow shaft.

13. The method of claim 10, further comprising connecting a cap to one of the first and second open ends.

14. The method of claim 10, further comprising connecting one or more extension tubes to one of the first and second open ends.
